(19) United States
(12) Patent Application Publication
(10) Pub. No.: US 2013/0201622 A1
(43) Pub. Date: Aug. 8, 2013

(54) Flash Drive

(71) Applicants: WEI-TING LIU, Hacienda Heights, CA (US); WEI-HUA LU, Taipei (TW); CHIH-KUEI HU, Jubei (TW)

(72) Inventors: WEI-TING LIU, Hacienda Heights, CA (US); WEI-HUA LU, Taipei (TW); CHIH-KUEI HU, Jubei (TW)

(21) Appl. No.: 13/365,354

(22) Filed: Feb. 3, 2012

(51) Int. Cl. G06F 1/16

(52) U.S. Cl. 361/679.32

(57) ABSTRACT

The present invention discloses a flash drive, including a first USB plug for receiving and transmitting data between a host and the flash drive; a second USB plug for receiving and transmitting data between a host and the flash drive; a flash memory for storing data; and a controller for receiving and transmitting data through the first USB plug or the second USB plug, and storing data to the flash memory or retrieving data from the flash memory; wherein the first USB plug is Type A USB interface plug for USB 1.x/2.0 or Standard A USB interface plug for USB 3.0.

### BACKGROUND OF THE INVENTION

1. Field of the Invention

The present invention relates to a flash drive, and more particularly, to a flash drive with more than one plug.

2. Description of the Prior Art

A small portable data storage device is a very important device for people nowadays. People need to carry their personal data or certain programs with them when they are not carrying their computer, or to transfer personal data or certain programs from one computer to another. At the beginning, floppy disks are the media of data storage, but this kind of media is not very stable. Optical disks like CD-ROM and DVD-ROM are stable storage media, but most of them are not reusable, and their reading and writing speeds are slow.

A flash drive with flash memory and Type-A Universal Serial Bus (USB) interface has overcome the drawbacks cited above. It has very high storage capacity, high reading and writing speeds, reliable and reusable. A traditional flash drive is shown in FIG. 1. The flash drive 100 comprises a Type-A USB interface plug 101 and a flash memory 103. The flash drive 100 can have very large storage capacity with portable size, but it only has one type plug. As the sizes of electronic products are shrinking year by year, more and more products utilized other interfaces. For example, many products such as pad computer or cell phone adapt Micro-A/Micro-B type USB interface for their compact size. How to improve the adaptability of flash drives is highly demanded.

### SUMMARY OF THE INVENTION

It is therefore a primary objective of the claimed invention to provide a flash drive with at least two USB plugs, one USB plug is a Type-A USB interface plug for USB 1.x/2.0 or a Standard-A USB interface plug for USB 3.0., the other USB plug is a different type of plug from Type-A USB plug or Standard-A USB plug.

According to an objective of the present invention, the present invention discloses a flash drive with a plurality of USB plugs, comprising a first USB plug and a second USB plug; the first USB plug is Type-A USB interface plug for USB 1.x/2.0 or Standard-A USB interface plug for USB 3.0; the second USB plug is physically smaller than the first USB plug.

The present invention also discloses a flash drive comprises a first USB plug and a second USB plug; the first USB plug is on a first edge of the flash drive, the second USB plug is on a second edge of the flash drive; wherein the first edge is an opposite edge of the second edge with respect to the flash drive.

The present invention further discloses a flash drive, including a first USB plug for receiving and transmitting data between a host; a second USB plug for receiving and transmitting data between a host; a flash memory for storing data; and a controller for receiving and transmitting data from the first USB plug or the second USB plug, and storing data to the flash memory or retrieving data from the flash memory; wherein the first USB plug is Type-A USB interface plug for USB 1.x/2.0 or Standard-A USB interface plug for USB 3.0.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a flash drive according to the prior art.

FIG. 2-1 is a diagram showing a flash drive according to an embodiment of the present invention.

FIG. 2-2 shows five types of USB plug cross-section diagrams.

FIG. 3 is an internal function block diagram of a flash drive according to an embodiment of the present invention.

FIG. 4 is an internal function block diagram of a flash drive according to another embodiment of the present invention.

FIG. 5 is a diagram showing flash drives according to another embodiments of the present invention.

FIG. 6 shows two USB 3.0 plug cross-section diagrams.

FIG. 7 is a diagram showing flash drives according to another embodiment of the present invention.

FIG. 8 is a diagram showing a flash drive according to another embodiment of the present invention.

FIG. 9 shows how different USB plugs are located at the same edge of the flash drive shown in FIG. 7 or FIG. 8.

FIG. 10 is a diagram showing a flash drive according to another embodiment of the present invention.

### DETAILED DESCRIPTION

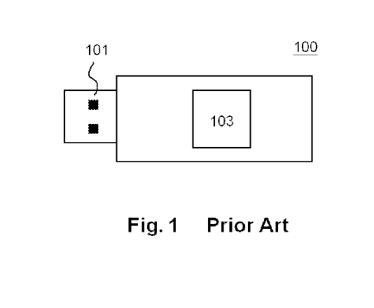

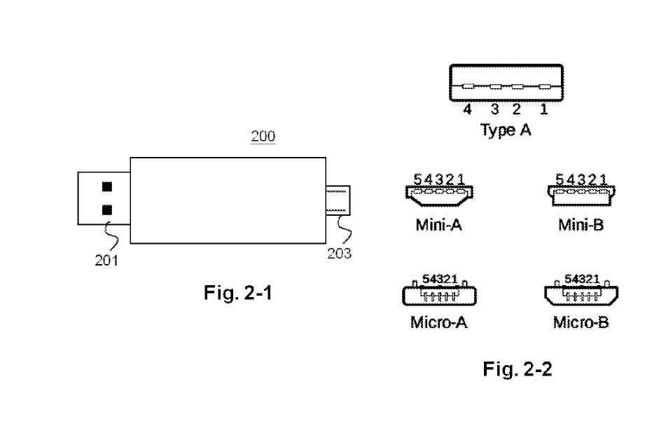

As more and more electronic devices adapt other transmission interfaces than Type-A USB interface, these other transmission interfaces embedded in a flash drive can facilitate the usage of different interfaces. The present invention provides a new structure of flash drive 200 as shown in FIG. 2-1. In FIG. 2-1, an interface 201, a Type-A USB interface plug for USB 1.x/2.0 or a Standard A USB interface plug for

USB 3.0, is shown. There is another transmission interface 203, a Micro-A or Micro-B USB interface plug, located on the opposite edge of the flash drive 200. Please refer to FIG. 2-2, another transmission interface 203 can also be a Mini-A or Mini-B USB interface plug, or any new developed USB interface other than Type-A USB interface.

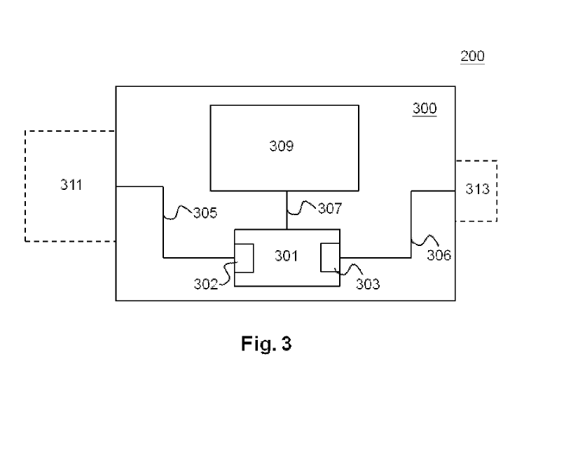

FIG. 3 shows the internal design of the flash drive 200. The body 300 of the flash drive 200 comprises a controller 301 and a flash memory 309. The controller 301 has two USB interface modules 302 and 303, the USB interface module 302 electrically connects to the Type-A/Standard-A USB plug 311 through the connection 305, and the USB interface module 303 electrically connects to the non-Type-A/Standard-A USB plug 313 through the connection 306. The controller 301 receives and transmits data through the USB interface module 302 or the USB interface module 303 from/to a host, which is a laptop computer, a desktop computer, a pad computer or a portable device.

When the flash drive 200 inserts into a host, the host sends reset signal to the flash drive 200. The USB interface module 302 or the USB interface module 303 receives the reset signal, and the controller 301 resets the flash drive 200. The controller 301 also connects to the flash memory 309 through a connection 307. The controller 301 receives data from the USB interface module 302 or the USB interface module 303, and stores the data to the flash memory 309. The host can also retrieves the data from the flash memory 309 by sending request to the controller 301, the controller 301 retrieves the data from the flash memory 309 and sends the data to the host through the USB interface module 302 or the USB interface module 303.

The controller 301 can further comprise an arbitrator module. The arbitrator module will detect whether the USB interface module 302 or the USB interface module 303 is connected to a host. If one of the USB interface modules is connected to the host, the arbitrator module will disable the other USB interface module.

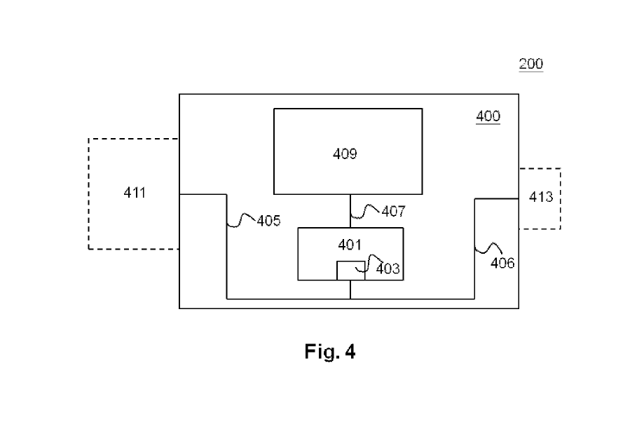

FIG. 4 shows another internal design of the flash drive 200.

The body 400 of the flash drive 200 comprises a controller 401 and a flash memory 409. The controller 401 has one USB interface modules 403 instead of two USB interface modules, the USB interface module 403 electrically connects to the Type-A USB/Standard-A plug 411 through the connection 405 and the non-Type-A USB/Standard-A plug 413 through the connection 406. Because some of the pins of the plug 411 are corresponding to some of the pins of the plug 413, these corresponding pins can be merged and connect to the controller 401. For example, pin 1 to pin 3 of USB 1.x/2.0 standard of a Type-A plug are corresponding to pin 1 to pin 3 of USB 1.x/2.0 standard of a Mini-A/Mini-B/Micro-A/Micro-B plug, pin 4 of USB 1.x/2.0 standard of a Type-A plug is corresponding to pin 5 of USB 1.x/2.0 standard of a Mini-A/Mini-B/Micro-A/Micro-B plug. In ordinary use of the flash drive 200, only one of the plug will be connected to a host. This embodiment illustrates a design eliminating an arbitrator module, so the cost of the flash drive 200 can be further declined. Other operations of this embodiment shown in FIG. 4 are similar to those shown in FIG. 3, and will not be illustrated here.

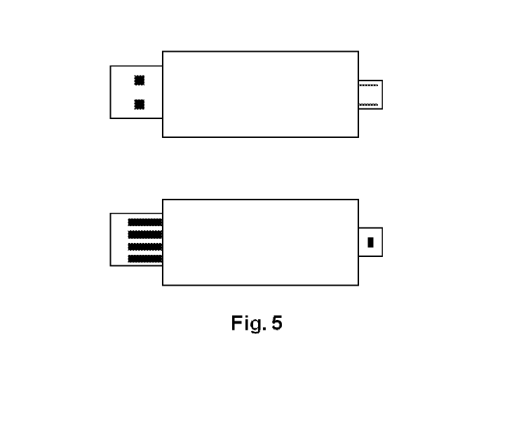

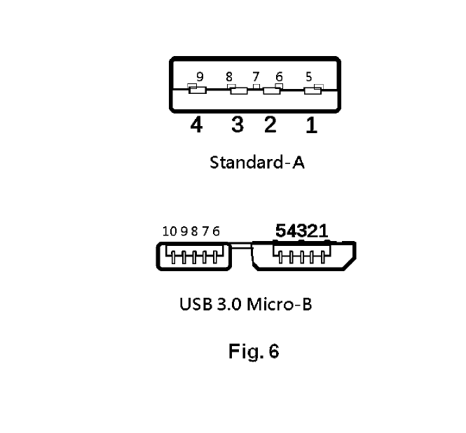

FIG. 5 shows different types of USB interface. In above figure, the flash drive comprises a Type-A USB plug and a Micro-A/Micro-B USB plug. In the below figure, the flash drive comprises a Type-A USB plug without the plug outside case and a Mini-A/Mini-B USB plug. The plugs of the flash drive can also be the Standard-B USB 3.0 plug and the USB 3.0 Micro-B plug shown in FIG. 6. Any variation combines a Type-A USB 1.x/2.0 plug or a Standard-A USB 3.0 plug and other smaller USB type plugs will not escape from the scope of this invention.

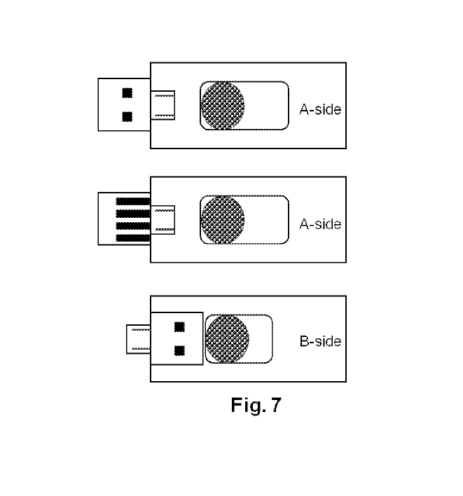

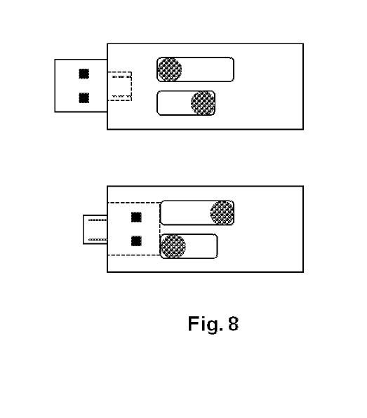

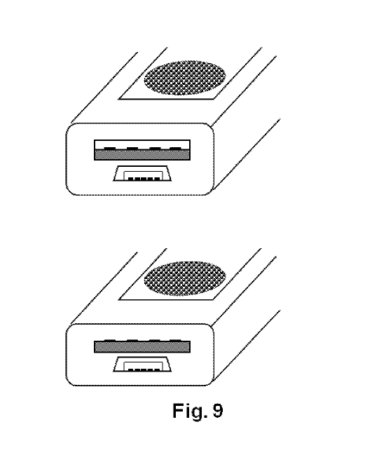

FIG. 7 shows another design of a flash drive different from the design shown in FIG. 2-1. Both of the USB plugs are in the same edge of the flash drive of FIG. 7. The top two figures of FIG. 7 shown one side (A-side) of the flash drive with a Type-A USB plug (with/without outside case) pushed out and a micro-A/micro-B USB plug pulled in. The bottom figure of FIG. 7 shows the other side (B-side, the opposite side of A-side) of the flash drive with a micro-A/micro-B USB plug pushed out and a Type A USB plug pulled in. The push/pull bottoms can also be placed on the same side as shown in FIG. 8. FIG. 9 shows how different plugs are located at the same edge of the flash drive shown in FIG. 7 or FIG. 8. The above figure of FIG. 9 comprises a type-A USB plug and a micro-B USB plug, the below figure of FIG. 9 comprises a type-A USB plug without outside case and a micro-B USB plug.

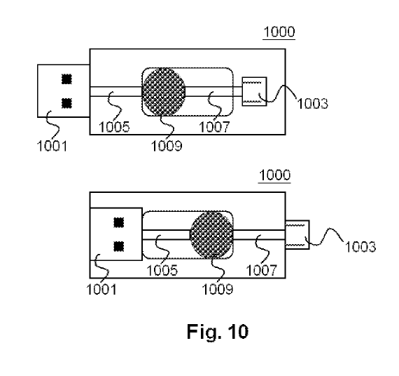

FIG. 10 shows another embodiment of a flash drive different from the flash drive shown in FIG. 2-1, FIG. 7 or FIG. 8. In FIG. 10, the flash drive comprises two bars 1005 and 1007 connect between the button 1009 and the USB plug 1001 and the button 1009 and the USB plug 1003 correspondingly. When the USB plug 1001 is pushed out, the bars will pull the USB plug 1003 back. On the other hand, when the USB plug 1001 is pulled back, the bars will push the USB plug 1003 out. The mechanism of the flash drive will only allow one USB plug being pushed out at once.

Those skilled in the art will readily observe that numerous modifications and alterations of the device and method may be made while retaining the teachings of the invention.

What is claimed is:

1. A flash drive, comprising a first Universal Serial Bus (USB) plug and a second USB plug, the first USB plug is Type A USB interface plug for USB 1.x/2.0 or Standard A USB interface plug for USB 3.0, the second USB plug is physically smaller than the first USB plug.

2. The flash drive of claim 1, further comprising:
a flash memory, for storing data, and a controller, for receiving and transmitting data through the first USB plug or the second USB plug, and storing data to the flash memory or retrieving data from the flash memory.

3. The flash drive of claim 1, wherein the second USB plug is a Micro-A USB interface plug , Micro-B USB interface plug, Mini-A USB interface plug, Mini-B USB interface plug or Standard B USB 3.0 plug.

4. The flash drive of claim 1, wherein the first USB plug is on a first edge of the flash drive, the second USB plug is on a second edge of the flash drive, the first edge is an opposite edge of the second edge with respect to the flash drive.

5. The flash drive of claim 1, wherein the first USB plug is on a first edge of the flash drive and the second USB plug is also on the first edge of the flash drive.

6. The flash drive of claim 1, wherein the first USB plug is on a first edge of the flash drive, the second USB plug is on a second edge of the flash drive, the first edge is an opposite edge of the second edge with respect to the flash drive;
wherein, the first USB plug is pushed out when the second USB plug is pulled in, and the first USB plug is pulled in when the first USB plug is pushed out.

7. A flash drive comprising:
a first Universal Serial Bus (USB) plug, on a first edge of the flash drive; and
a second USB plug, on a second edge of the flash drive;
wherein the first edge is an opposite edge of the second edge with respect to the flash drive.

8. The flash drive of claim 7, wherein the first USB plug is Type A USB interface plug for USB 1.x/2.0 or Standard A USB interface plug for USB 3.0.

9. The flash drive of claim 7, wherein the second USB plug is a Micro-A USB interface plug , Micro-B USB interface plug, Mini-A USB interface plug, Mini-B USB interface plug or Standard B USB 3.0 plug.

10. The flash drive of claim 7, further comprising:
a flash memory, for storing data, and a controller, electrically connected to the flash memory, the first USB plug and the second USB plug, for receiving and transmitting data through the first USB plug or the second USB plug, and storing data to the flash memory or retrieving data from the flash memory.

11. The flash drive of claim 10, wherein the controller further comprises an arbitrator, wherein the arbitrator will disable the second USB plug when the first USB plug is electrically connected to a host, or the arbitrator will disable the first USB plug when the second USB plug is electrically connected to a host.

12. The flash drive of claim 10, wherein some of the first USB plug pins and some of the second USB plug pins are merged and connected to the controller.

13. A flash drive, comprising:
a first USB plug, for receiving and transmitting data between a host and the flash drive;
a second USB plug, for receiving and transmitting data between a host and the flash drive;
a flash memory, for storing data; and
a controller, electrically connected to the flash memory, the first USB plug and the second USB plug, for receiving and transmitting data through the first USB plug or the second USB plug, and storing data to the flash memory or retrieving data from the flash memory;
wherein the first USB plug is Type A USB interface plug for USB 1.x/2.0 or Standard A USB interface plug for USB 3.0.

14. The flash drive of claim 13, wherein the second USB plug is a Micro-A USB interface plug , Micro-B USB interface plug, Mini-A USB interface plug, Mini-B USB interface plug or Standard B USB 3.0 plug.

15. The flash drive of claim 13, wherein the first USB plug is on a first edge of the flash drive, the second USB plug is on a second edge of the flash drive, the first edge is an opposite edge of the second edge with respect to the flash drive.

16. The flash drive of claim 13, wherein the first USB plug is on a first edge of the flash drive and the second USB plug is also on the first edge of the flash drive.

17. The flash drive of claim 13, wherein the first USB plug is on a first edge of the flash drive, the second USB plug is on a second edge of the flash drive, the first edge is an opposite edge of the second edge with respect to the flash drive, wherein, the first USB plug is pushed out when the second USB plug is pulled in, and the first USB plug is pulled in when the first USB plug is pushed out.

18. The flash drive of claim 13, wherein the controller further comprises an arbitrator, wherein the arbitrator disables the second USB plug when the first USB plug is electrically connected to a host, or the arbitrator disables the first USB plug when the second USB plug is electrically connected to a host.

19. The flash drive of claim 13, wherein some of the first USB plug pins and some of the second USB plug pins are merged and connected to the controller.
